(19) United States
(12) Patent Application Publication
(10) Pub. No.: US 2015/0248539 A1
(43) Pub. Date: Sep. 3, 2015

(54) METHOD FOR REDUCING ERRORS IN MEDICATION ADMINISTRATION BY MEDICAL PROFESSIONALS AND NON-CLINICAL INDIVIDUALS

(71) Applicant: Raymond E. Washburn, Pittsburgh, PA (US)

(72) Inventor: Raymond E. Washburn, Pittsburgh, PA (US)

(21) Appl. No.: 14/633,091

(22) Filed: Feb. 26, 2015

Related U.S. Application Data
(60) Provisional application No. 61/945,033, filed on Feb. 26, 2014.

(51) Int. Cl. G06F 19/00

(52) U.S. Cl. CPC G06F 19/3456

(57) ABSTRACT

A method for reducing errors in medication administration comprises: (a) providing a computer program for a mobile handheld electronic device that includes a feature that visually verifies an intended recipient of each medication before medication is administered to the recipient and a feature that visually verifies the medication to be administered before each medication-administering event. Next, each medication-administering individual is provided with access to this mobile handheld device and training on how to run the computer program installed thereon.

### CROSS-REFERENCE TO RELATED APPLICATION

This is a perfection of U.S. provisional application Ser. No. 61/945,033, filed on Feb. 26, 2014, the disclosure of which is fully incorporated by reference herein.

### FIELD OF THE INVENTION

The present invention relates to the field of hospital and rest home care staffing as well as care providing at home or in-residence. More particularly, this invention relates to means for better insuring the proper delivery of medicines (and other care) to patients/residents by medical personnel in facility and by non-clinical caregivers (spouses, family members and others) at home. The invention offers an electronic application (or “app”) for a device such as a SmartPhone®, Android®, iPad® or other brand of “tablet”. Preferably, this application or app easily synchronizes with other electronic data storage media throughout a given facility.

### BACKGROUND OF THE INVENTION

There is a growing problem with staffing in hospitals and related medical facilities. The same applies to long care, nursing homes and to the administering of medicines to individuals being attended to by non-clinical individuals (spouses, family members) while at home.

Nurses administer medication to hospital patients and to many residents of a nursing home. However, the nursing population is shrinking while the elderly population continues to grow. One 2008 report estimated that a 30% annual increase in nursing graduates will be needed to fill expected vacancies. To overcome such a shortage, this group will need a complementary workforce. However, in some states, it is illegal besides anyone other than a nurse to administer most medications. Why? There is a worry that an employee without a nursing education will make more errors and endanger the facility residents.

Below are just a few commonly identified potential sources of error that could be a concern for the non-nurse delivery/dispensing of medicines to patients/long term care residents:
Errors with Medication Instructions
Unable to identify pills by name
Medication schedule complexity
Misidentification of Residents
Errors due to Distractions

An app like the present invention may not eliminate the possibility of all human error but it CAN help reduce or possibly eliminate some of the foregoing chances of mistakes.

### SUMMARY OF THE INVENTION

This invention addresses a SmartPhone®, Android®, other cell phone application and/or larger iPad® or other tablet variety for managing the medication records of the residents of a nursing home. The app is designed to mitigate or eliminate identified sources of error. In other words, the method of this invention will assist medicine providers (whether professional or non-clinical) from NOT making the “next” mistake by inaccurately delivering the wrong medicine to the wrong recipient.

With proper usage (after some training) and proper synchronization of “live” record keeping, many of the foregoing errors in patient/long term resident care can be avoided . . . particularly with greater involvement of/participation by non-nurse personnel/staff.

### BRIEF DESCRIPTION OF THE PHOTOGRAPHS

Further features, objectives and advantages of this invention will become clearer with the following detailed description made with reference to the accompanying photographs in which:

FIG. 1 is photograph of one section of a patient/resident's medication administration record (or MAR) showing the manual entry of data thereon and the initialization by personnel upon the completion of certain timed tasks;

FIG. 2 is a photograph of the front to one representative medication packet for handling by the right trained medication administering personnel;

FIG. 3 is a photograph of one representative binder of medical administration records which can be supplemented or wholly superseded by a system employing the methods/app's of the present invention;

FIG. 4 is a representative photographic display of a patient/resident to be compared by the user before a medication is supplied to same under the system and method of this invention;

FIG. 5 is a representative photographic display of a given drug dosage (in size/shape/color) to be compared by the user before that medication is delivered to a patient/resident under the system and method of this invention;

FIG. 6 is a representative display from the system/app of this invention showing (from left to right): a particular patient/resident's overall medication “schedule”; the various residents in a given region/work shift that that user will need to be addressing/administering medications to; and the still undelivered medications for the patient/resident currently being attended to by the user; and

FIG. 7 is a representative series of device screenshots showing how supervisory staff can be summoned by the user in the event of an emergency (or need to have a question answered/addressed in a hurry.

### DESCRIPTION OF PREFERRED EMBODIMENTS

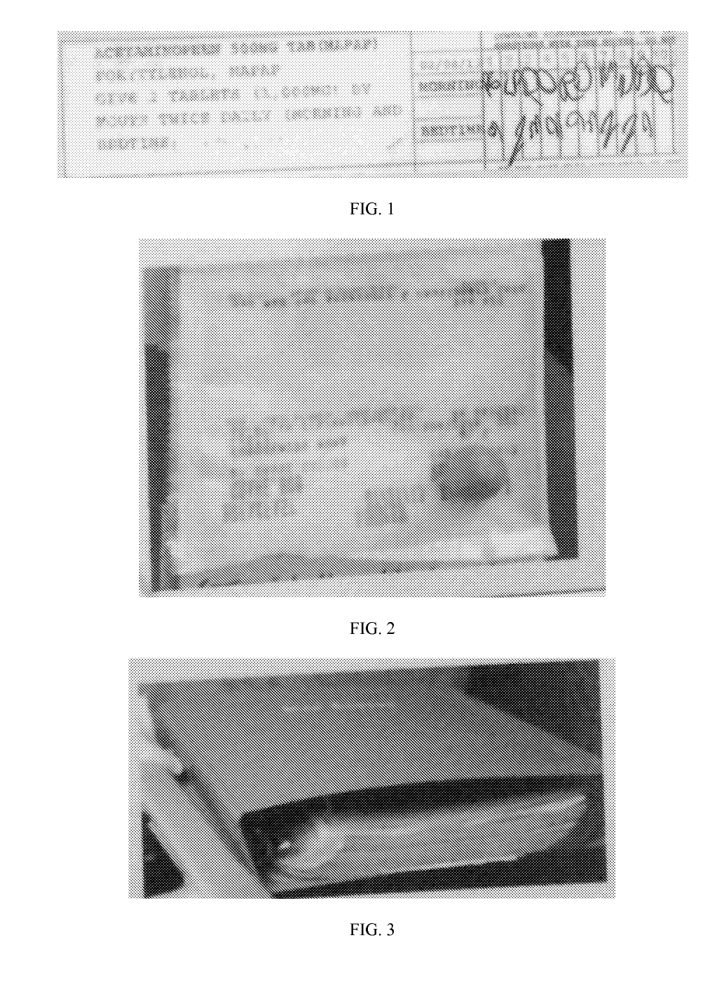

FIG. 1 is a sample patient/resident's Medication Administration Record. Note how in this example, the twice a day administration of one medicine is manually noted and initialed by the professional administering the same to that patient/resident. It is a tedious system that is highly susceptible to human error and misreads.

The system can be especially difficult for an untrained person, creating some sources of error:

Errors with instructions with giving some medication—The above sample gives instructions. For some meds, however, more complicated steps may be involved (and/or required in advance) and undocumented, such as the taking of the patient/resident's blood pressure prior to medication administration to same.

Unable to identify pills by name—A name is provided for the med needed, but no picture. Also meds are packaged as per the label pictured at FIG. 2. An administrator may be sure he/she has the right “set” of meds to give, but how can one be sure which is which?

Medication schedule is complex so might miss an appointment—The above is a sample of 1 row for 1 patient. Note, however, that some patients may have 9+ meds to receive, and the person administering medications to that one individual may be responsible for a dozen residents in addition to the first one. (The photograph at FIG. 3 is a typical binder compilation of such sheets.) With that many residents and schedules, it can be difficult to keep them straight.

### Description of the Overall App Design

This concept is being developed as a prototype. It is meeting various design criteria and should be robust enough to take it through initial evaluation through a series of simulations to evaluate the app's effectiveness. Those results will be used in a next generation app for more robust simulation testing on a larger scale at one or more sections of a nursing home facility.

While design development and prototype testing continues, it is believed that the present invention will offer a new approach to medication management not only in Long Term Care but also for residents and families in their homes. This approach should quickly transfer to other levels of care for medication management.

The primary design goal is to give a non-licensed person the ability to successfully manage medications at the same or lower error rate as today's professionally licensed staff.

The app is intended for permanent installation on a cell phone or tablet. In the FIGS that follow, the various app views are as would be shown on a representative Nexus 10 device. Each user will carry such a device around with them. At times, when medications are supposed to be given, the user will check the app to see: (i) who needs what medication; (ii) when; and (iii) how to give/administer it.

It is anticipated that this phone/tablet application may also be installed for use by individual, private care providers, in one's own home. For instance, where the patient/resident is being discharged from a multi-patient facility, it would be feasible for the home care giver/provider to have this same application installed onto his/her own mobile device and all of the medication information specific for that individual transferred thereon. With some advance training on the app, over several days, preferably BEFORE the patient/resident is released, the new system user can be brought up to speed on how to best track their returnees medication needs using this application.

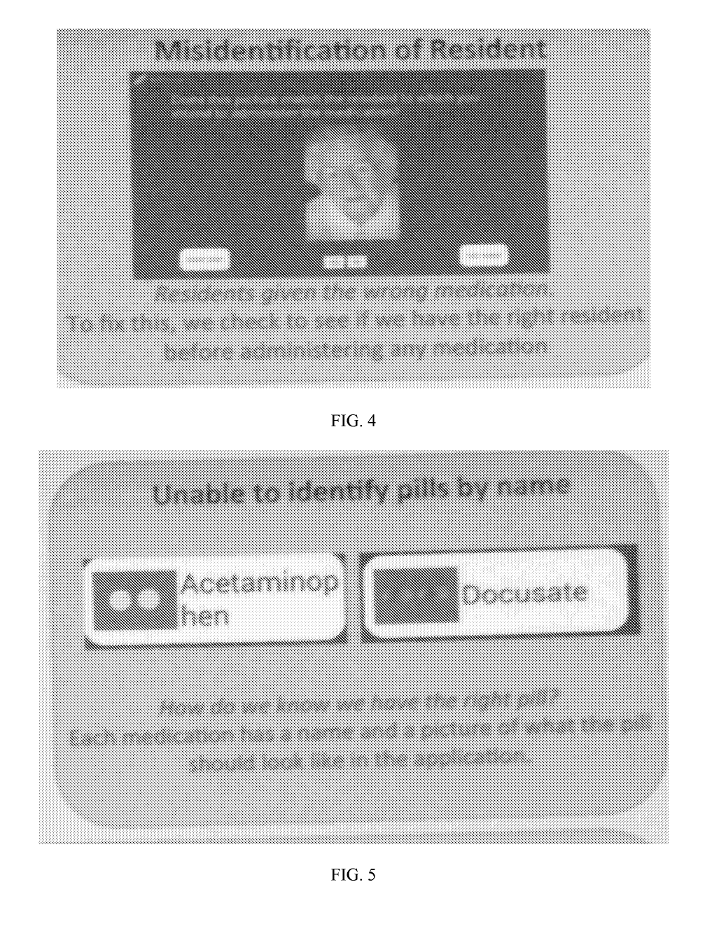

This invention should help to reduce or eliminate altogether several common sources of medication administration error. These include:
Misidentification of Resident—FIG. 4

A resident may be given a medication but not necessarily the right medication. To fix that, the system of this invention will first visually verify (not just by wristband ID's) whether the intended recipient is the correct resident before any medication is administered.
Unable to identify pills by name—FIG. 5

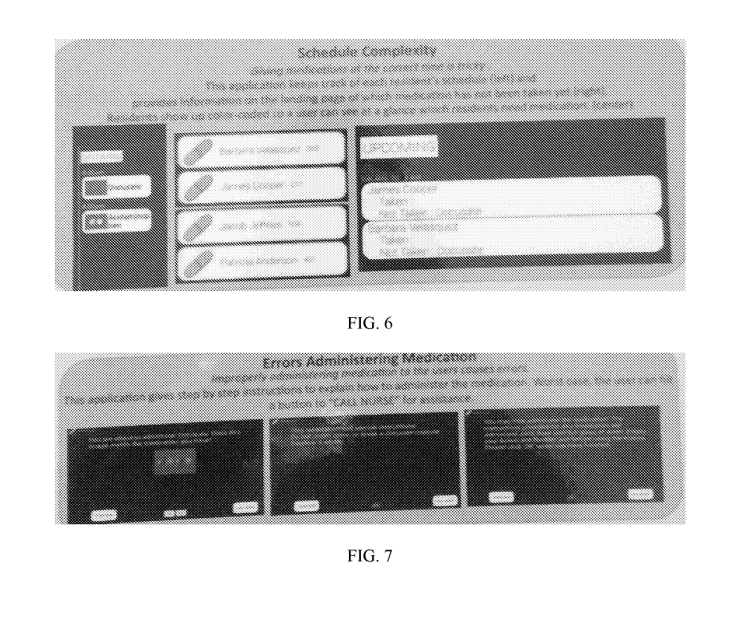

How does the administrator know he/she has the right pill? Each medication has a name AND a picture of what the pill should look like in the app.
Schedule Complexity—FIG. 6

Administering medications at the proper time can get quite tricky. The app of this invention will better track each resident's schedule (see, the left most panel in FIG. 6) and provide information on the “landing page” of which medication(s) has/have NOT been taken yet (right side of FIG. 6). Residents will appear (show up), color-coded so that a user can see at a glance which of the residents still need their medication for that given day/shift (middle panel of FIG. 6).
Errors Administering Medication

Improperly administering medication to a user causes errors. This application will give step-by-step instructions to explain how to administer the medication. Worst case, the user can hit a “panic” button to CALL NURSE for assistance. See the sequence of photos comprising FIG. 7.
Errors due to Distractions

The outside world has many distractions—phone calls, interactions with people, etc. To mitigate this, the app gives notifications to the user when residents have not taken their medicine during a preset time. It will also provide visual (and/or audio) alerts for telling its users which patients/residents are no longer taking a given medication so as to reduce the chance of drug overdosing with the next medication administration.

What is claimed is:

1. A method for reducing errors in medication administration comprises the steps of:
(a) providing a computer program for a mobile handheld electronic device, said computer program including:
(i) a feature that visually verifies an intended recipient of each medication before said medication is administered to the intended recipient;
(ii) a feature that visually verifies the medication to be administered before each medication-administering event;
(b) providing each medication-administering individual with access to a mobile handheld device on which the computer program has been loaded; and
(c) providing each medication-administering individual with training on how to run the computer program on the mobile handheld device.

2. The method of claim 1 wherein the medication-administering individual is a medical professional.

3. The method of claim 2 wherein the medical professional is a nurse.

4. The method of claim 1 wherein the intended recipient has been sent to a non-medical or long term care facility and the medication-administering individual is a non-clinical individual.

5. The method of claim 4 wherein the intended recipient has been sent home and the non-clinical individual is a spouse, other family member or friend.

6. The method of claim 1 wherein the handheld electronic device is a computer tablet or mobile cell phone.

7. The method of claim 1 wherein the computer program further includes a feature that synchronizes each medication-administering event for the intended recipient with medical records for that intended recipient at a medical or long term care facility where the intended recipient is being treated.

8. The method of claim 1 wherein the computer program further includes a feature that synchronizes each medication-administering event for the intended recipient with medical records for that intended recipient at a medical or long term care facility where the intended recipient was last treated.

9. The method of claim 1 wherein the computer program further includes a feature that synchronizes each medication-administering event and notifies the medication-administering individual when the next medication-administering event is scheduled for that intended recipient.

10. The method of claim 9 wherein the feature that notifies the medication-administering individual when the next medication-administering event is scheduled for that intended recipient includes an audio and/or visual alarm.

11. The method of claim 1 wherein the intended recipient is part of a multiple patient or resident facility and the computer program further includes a feature that notifies the medication-administering individual when a next medication-administering event is scheduled for each intended recipient for whom that medication-administering individual has medication-administering responsibility.

12. A method for reducing errors in medication administration in a multiple patient or resident facility, said method comprising the steps of:
(a) providing a computer program for a mobile handheld electronic device, said computer program including:
(i) a feature that visually verifies an intended recipient of each medication before said medication is administered to the intended recipient;
(ii) a feature that visually verifies the medication to be administered before each medication-administering event; and
(b) providing each medication-administering individual at the multiple patient or resident facility with access to a mobile handheld device on which the computer program has been loaded.

13. The method of claim 12, which further includes: providing each medication-administering individual with training on how to run the computer program on the mobile handheld device.

14. The method of claim 12 wherein the handheld electronic device is a computer tablet or mobile cell phone.

15. The method of claim 12 wherein the computer program further includes a feature that synchronizes each medication-administering event for the intended recipient with medical records for that intended recipient.

16. The method of claim 12 wherein the computer program further includes a feature that synchronizes each medication-administering event and notifies the medication-administering individual when the next medication-administering event is scheduled for that intended recipient.

17. The method of claim 16 wherein the feature that notifies the medication-administering individual when the next medication-administering event is scheduled for that intended recipient includes an audio and/or visual alarm.

18. A method for reducing errors in medication administration by a non-clinical individual to an intended recipient at a non-medical or long term care facility, said method comprising the steps of:
(a) providing a computer program for a mobile handheld electronic device, said computer program including:
(i) a feature that visually verifies for the non-clinical individual the medication to be administered to the intended recipient before each medication-administering event; and
(ii) a feature that notifies the non-clinical individual when the next medication-administering event is scheduled for the intended recipient;
(b) providing the non-clinical individual with access to a mobile handheld device on which the computer program has been loaded; and
(c) providing the non-clinical individual with training on how to run the computer program on the mobile handheld device.

19. The method of claim 18 wherein the non-clinical individual is a spouse, other family member or a friend.

20. The method of claim 1 wherein the handheld electronic device is a computer tablet or mobile cell phone.
